(19) United States
(12) Patent Application Publication
(10) Pub. No.: US 2011/0310965 A1
(43) Pub. Date: Dec. 22, 2011

(54) COMMUNICATION DEVICE, COMMUNICATION METHOD, AND COMMUNICATION PROGRAM PRODUCT

(75) Inventors: Yasuyuki NISHIBAYASHI, Kanagawa (JP); Shinya MURAI, Kanagawa (JP); Masataka GOTO, Kanagawa (JP); Kensaku YAMAGUCHI, Kanagawa (JP); Hiroshi KAWAZOE, Kanagawa (JP)

(73) Assignee: KABUSHIKI KAISHA TOSHIBA, Tokyo (JP)

(21) Appl. No.: 13/108,222

(22) Filed: May 16, 2011

Related U.S. Application Data
(63) Continuation of application No. PCT/JP2009/068800, filed on Nov. 4, 2009.

(30) Foreign Application Priority Data
Nov. 14, 2008 (JP) 2008-291780

(51) Int. Cl. H04N 7/26

(52) U.S. Cl. 375/240.08; 375/E07.026

(57) ABSTRACT

According to one embodiment, a communication device includes an image storage unit storing a display image, an update image generation unit generating an update image used to update the display image, a detection unit detecting a difference region representing a region in which pieces of pixel information do not match between the update image and the display image, and a compression image generation unit generating a difference region compression image. The communication device further includes a moving picture generation unit generating a moving picture at a designated frame rate, a control unit comparing the size of the difference region with a first threshold and performs control of decreasing a frame rate designated to the moving picture generation unit when the size of the difference region is larger than the first threshold, and a transmission unit transmitting the compression image and the moving picture to the display device.

### CROSS-REFERENCE TO RELATED APPLICATIONS

This application is a continuation of PCT international application Ser. No. PCT/JP2009/068800 filed on Nov. 4, 2009 which designates the United States; the entire contents of which are incorporated herein by reference.

### FIELD

Embodiments described herein relate generally to a communication device, a communication method, and a communication program product for implementing a function of sharing a screen of an application between devices.

### BACKGROUND

There exists a computing system in which in order to improve usability, a terminal device having a minimum input/output (I/O) interface is arranged at a user side, and a complicated arithmetic process is executed on a communication device arranged at a remote side. For example, in U.S. Pat. No. 6,784,855, a technique related to a system (a screen transmission system) that projects screen information of a communication device personal computer, a server computer, or the like) on a remote display device (a display terminal) via a network has been proposed.

In this system, input information (pen input by a digitizer or the like) from the display terminal is similarly transmitted to the communication device via the network, and an actual application program process is executed by the communication device. Thereafter, the result of an execution and screen update information are transmitted to the display terminal via the network. The display terminal executes an output process (a rendering process) based on the received screen update information.

Meanwhile, as a technique for effectively transmitting screen information from the communication device on the remote network to the display device, virtual network computing (VNC) has been known. In the VNC, when a screen update is detected, a value of read pixel information is compared with a value of pixel information transmitted to the display terminal the last time to decide an update screen region changed from the last time. The update screen region is subjected to still image compression, and only difference information of a compressed screen is transmitted to the display device. As a result, consumption of a communication band, can be reduced. Thus, in the case in which a change in screen is large, such as the case of movement of a window, the amount of a screen information to be transmitted increases, whereas in the case in which a change in screen is small, the amount of a screen information to be transmitted decreases.

Further, a multimedia system that can provide a video streaming function of transmitting multimedia contents such as video data (video information), photographic data, music data, or the like that are stored in an external storage device, such as a hard disk drive (HDD) or a solid state drive (SDD), connected to a communication device via a network and browsing the multimedia contents from a remote display terminal has been known.

For example, a universal plug and play (UPnP) defines a technical specification for mutually connecting audio visual devices such as a personal computer, a peripheral device, a television, a HDD recorder, and the like in home. There is also a digital living network alliance (DLNA) that defines a broader technical specification such as a communication method, a transmission control method, and a kind of contents to be dealt. In this system, a client terminal discovers a server device on a network and browses the contents on the server device by streaming reproduction.

In the above described multimedia system, a type of video information stored in an external storage device of the communication device may be different from a type of video information that can be reproduced by the display terminal. For example, let us assume that video information of a communication device side is a WMV format, and video information that can be reproduced by the display device is an MPEG-2 (generic coding of moving pictures and associated audio information) format. In this case, a user cannot browse the video information of the communication device through the display device. Thus, in this situation, a method in which the communication device converts (transcodes) the video information into a format that can be reproduced by the display device may be considered.

The transcoding process refers to a process of first performing a decoding process of video information and then encoding the decoded information into a new format. In the above described example, the video information of the WMV format is first decoded and then encoded into video information of the MPEG-2 format based on a predetermined frame rate or bit rate condition. Generally, the transcoding process of the video information is a process requiring high computation complexity.

In the case in which the communication device provides functions of both the screen transmission system and the multimedia system described above, the process of generating a transmission image to be transmitted to the display device (the process of performing the still image compression on the update screen region) may be performed at the same time as the process of transcoding the video information. In this situation, there may be arisen a problem in that the computation complexity of the communication device greatly increases.

In JP-A 2003-274358 (KOKAI), in an imaging device with a two-way imaging element, a technique of changing an imaging input frame rate based on a predetermined priority when a subject is detected in one direction has been proposed. Thus, recording and transmitting of appropriate video information according to a situation are implemented.

JP-A 2003-274358 (KOKAI) discloses the technique for the case of performing video input of two or more directions but does not disclose the technique of adjusting the computation complexity of the communication device with a plurality of functions described above. If the technique of JP-A 2003-274358 (KOKAI) is applied to the above described communication device, there may be considered a technique of decreasing a frame rate of video streaming when a plurality of functions start their operations.

However, if a technique of performing control of decreasing qualities of the other functions when a specific function starts its operation is applied as in Patent JP-A 2003-274358 (KOKAI), there is a possibility that an adjustment of the computation complexity will be ineffective.

For example, in the above described screen transmission system, when the screen of the communication device is not updated at all or when the area of an update region is small like in the case of the screen update by the user's mouse operation, since the computation complexity accompanied with transmission image generation is low, the performance can be maintained without decreasing the frame rate of video streaming. However, if the technique of Patent JP-A 2003-274358 (KOKAI) is simply applied, since the frame rate of video streaming decreases when the screen transmission system starts, it may possibly decrease the quality unnecessarily.

### BRIEF DESCRIPTION OF THE DRAWINGS

FIG. 1 is a block diagram illustrating a configuration of a communication system according to a first embodiment;

FIG. 2 is a block diagram of a communication device according to the first embodiment;

FIG. 3 is a block diagram of a display terminal according to the first embodiment;

FIG. 4 is a flowchart illustrating the overall flow of an image transmission process in the first embodiment;

FIG. 5 is a sequence diagram illustrating an operation example of the communication device of the first embodiment;

FIG. 6 is a block diagram illustrating a configuration of a communication device according to a second embodiment;

FIG. 7 is a diagram illustrating an example of a data structure of a threshold stored in a condition storage unit of the second embodiment;

FIG. 8 is a flowchart illustrating the overall flow of a video information transmission process in the second embodiment;

FIG. 9 is a flowchart illustrating the overall flow of a threshold change process in the second embodiment;

FIG. 10 is a sequence diagram illustrating an operation example of the communication device of the second embodiment;

FIG. 11 is a sequence diagram illustrating an operation example of the communication device of the second embodiment; and

FIG. 12 is a diagram illustrating a hardware configuration of the communication device and the display device according to the first and second embodiments.

### DETAILED DESCRIPTION

In general, according to one embodiment, a communication device includes an image storage unit storing a display image, an update image generation unit generating an update image used to update the display image, a detection unit detecting a difference region representing a region in which pieces of pixel information do not match between the update image and the display image, and a compression image generation unit generating a difference region compression image. The communication device further includes a moving picture generation unit generating a moving picture at a designated frame rate, a control unit comparing the size of the difference region with a first threshold and performs control of decreasing a frame rate designated to the moving picture generation unit when the size of the difference region is larger than the first threshold, and a transmission unit transmitting the compression image and the moving picture to the display device.

Hereinafter, exemplary embodiments of a device, a method, and a program will be described in detail with reference to the accompanying drawings.

### First Embodiment

A communication system according to a first embodiment includes a communication device that executes an application and a display terminal (a display device) that displays a screen updated by execution of an application. The communication device performs control of decreasing a frame rate during generation of video (moving picture) when a difference region of image information generated by an operation of an application program is larger than a predetermined threshold.

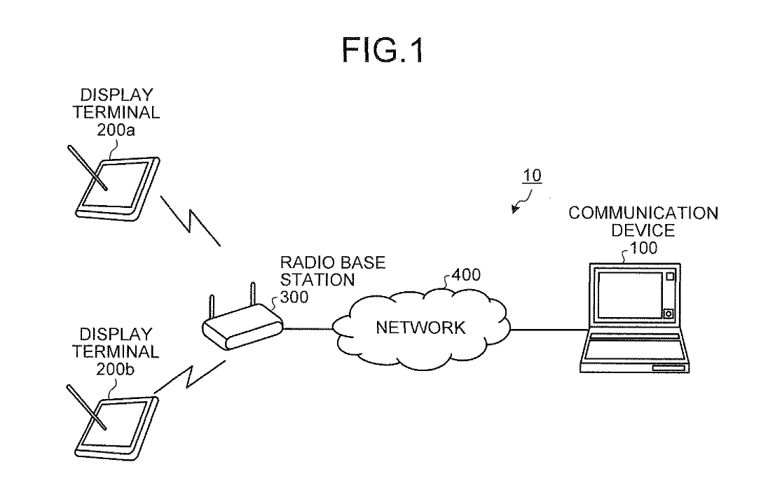

FIG. 1 is a block diagram illustrating the configuration of the communication system according to the first embodiment. The communication system is a system that transmits an image of an updated part by an event occurred on a screen of the communication device to the display terminal. Hereinafter, the communication system is referred to as a screen transmission system.

As illustrated in FIG. 1, a communication system 10 according to the first embodiment includes a communication device 100 as a communication device, a radio base station 300 as an access point connected with the communication device 100 via a network 400, and display terminals 200a and 200b (hereinafter, also referred to as “display terminals 200”) as display devices that perform wireless communication with the radio base station 300 through a wireless local area network (LAN).

The communication system 10 has a function of transmitting in a wireless manner a screen of application software operating on the communication device 100 to the display terminal 200 through the radio base station 300 and displaying and sharing the application screen of the communication device 100 with the display terminals 200. In the communication system 10, in order to transmit the screen updated by the communication device 100 side to the display terminal 200 in real time, only image information of the updated part within the screen of the communication device 100 is transmitted. That is, the communication device 100 can transmit the image information to the display terminal 200 that displays the image information through the radio base station 300.

Further, the communication device 100 has a function of acquiring video information on an external storage device (not shown in FIG. 1), generates new video information to be displayed on the display terminal 200, and transmits the new video information. Hereinafter, a system that converts and then transmits video information is referred to as a video streaming system. In the example of FIG. 1, the communication device 100 wirelessly transmits the generated new video information to one display terminal 200 through the radio base station 300. For example, the display terminal 200a and the communication device 100 implement the screen transmission system, and the display terminal 200b and the communication device 100 implement the video streaming system. That is, the communication device 100 can provide a plurality of display terminals 200 with a plurality of different functions at the same time.

However, when the communication device 100 simultaneously operates a plurality of processes having high computation complexity such as generation of a transmission image or conversion of video information, there may be arisen a problem in that a display response of the update screen in the display terminal 200 deteriorates due to a shortage of available resources. As the causative factor of this problem, there may be considered an increase in generation time of the transmission image by the communication device 100 or an increase in transmission delay attributable to a lot of traffic flowing on a wireless transmission line. Further, in the screen transmission system, since the user performs an input operation while updating a desktop screen of the communication device 100, it is important to maintain a response characteristic related to the screen display. Thus, in the first embodiment, it is possible to provide a plurality of display terminals 200 with a plurality of different functions without deterioration of the response characteristic of the display terminal 200 that remotely controls the screen of the communication device 100.

The display terminal 200 receives the image information from the communication device 100, expands the received image information, and displays the expanded image information on a corresponding part within the screen. The display terminal 200 reproduces multimedia data received from the communication device 100 through a display or a speaker.

The radio base station 300 is a radio communication base station that conforms to a radio communication protocol such as IEEE 802.11. The network 400 is a network that conforms to a wire line communication protocol such as IEEE 802.3. The network type is not limited thereto and may be configured to perform a connection to conform any other protocols. Further, the display terminal 200 may be connected with the communication device 100 via a wire line network.

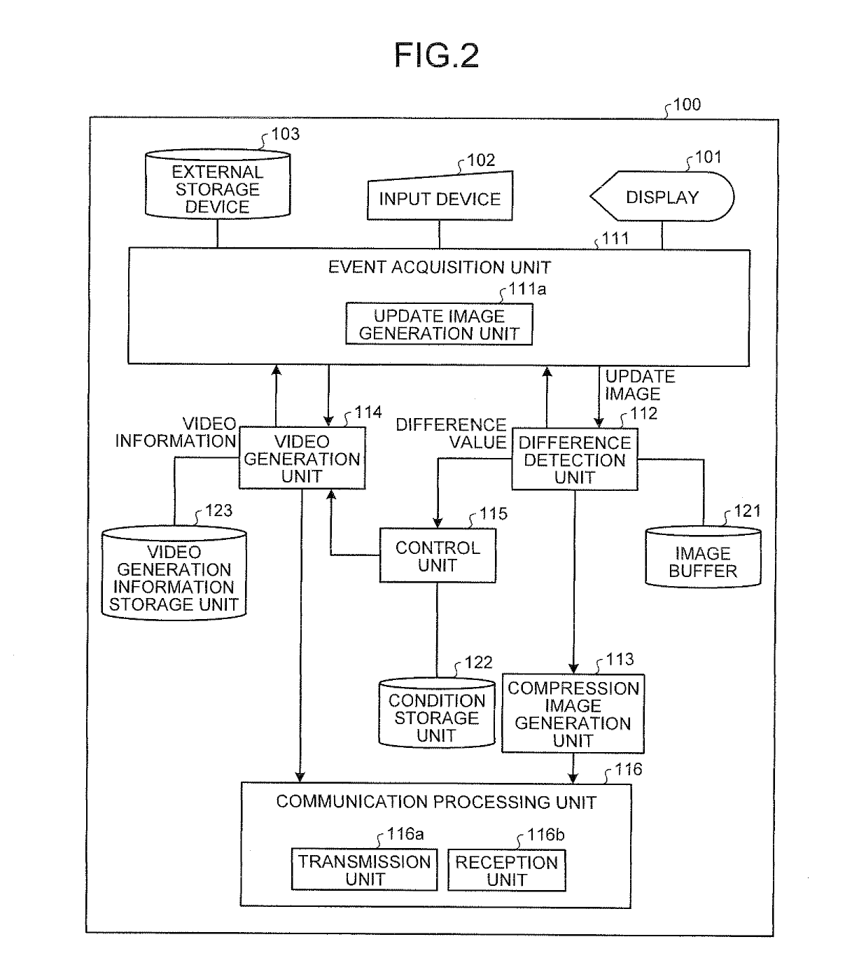

Next, the detailed configuration of the communication device 100 will be described with reference to FIG. 2. FIG. 2 is a block diagram of the communication device 100 according to the first embodiment. As illustrated in FIG. 2, the communication device 100 includes a display 101, an input device 102, an external storage device 103, an image buffer 121, a condition storage unit 122, a video generation information storage unit 123, an event acquisition unit 111, a difference detection unit 112, a compression image generation unit 113, a video generation unit 114, a control unit 115, and a communication processing unit 116.

The display 101 is a display device that is implemented by a liquid crystal display (LCD) or the like. The input device 102 is implemented by a mouse that performs an operation of moving a cursor displayed on the screen of the display 101 or the like. As the input device 102, a keyboard, a trackball, or the like may be used.

The external storage device 103 is implemented by a high capacity storage device such as a HDD or an SDD. The external storage device 103 stores the multimedia contents such as video data (video information), music data, photographic data, or the like.

The image buffer 121 is a storage unit that stores an image. The condition storage unit 122 stores a threshold (a first threshold) of the size (the number of pixels) of image information as a condition that the control unit 115 uses for a judgment. For example, the condition storage unit 122 stores the total number of pixels obtained by multiplying the number of pixels in a vertical width of image information by the number of pixels in a horizontal width, that is, a predetermined threshold derived based on an area value of pixels.

The video generation information storage unit 123 stores video generation information to which the video generation unit 114 refers when generating new video information. For example, the video generation information includes a frame rate, a bit rate, a resolution, a coding method, and the like of video information to be generated. When a plurality of display terminals 200 are connected to the communication device 100, a plurality of pieces of video generation information may be prepared for each of the display terminals 200.

Incidentally, the image buffer 121, the condition storage unit 122, and the video generation information storage unit 123 may be configured by any kinds of storage media that are generally used, such as a HOD, an optical disk, a memory card, a random access memory (RAM), or the like.

The event acquisition unit 111 acquires an event that occurs due to an operation of an application program (not shown) or the like. For example, the event acquisition unit 111 is implemented by an operating system (OS) that generally controls a computer, a virtual display driver that has the same function as a display driver incorporated into the OS, and an application program such as application software that operates on the OS.

The event acquisition unit 111 acquires, as an event, what the screen (image) is updated when the screen is updated by the application software or when the cursor is moved/operated by the mouse operation or the like and so an image of an arbitrary region within the screen is updated.

The event acquisition unit 111 includes an update image generation unit 111a as a detailed configuration thereof. For example, the update image generation unit 111a may be implemented as the virtual display driver incorporated into the OS. When the event of the screen update is acquired, the update image generation unit 111a generates a display image representing an image to be displayed on the display terminal 200 by acquiring a rendering command from a graphic engine of the OS and performing a rendering process, and sequentially outputs the display image to be stored in the image buffer 121. As a result, the display image is sequentially retained in the image buffer 121.

Hereinafter, an image retained in the image buffer 121 is referred to as a display image, and an update image that is newly generated by the update image generation unit 111a but not stored in the image buffer 121 yet is referred to as an update image. As described above, the update image generation unit 111a generates the update image, which is to be displayed on the display terminal 200, according to the event that occurs due to the operation of the application program.

The difference detection unit 112 detects a difference region representing a region in which pieces of pixel information do not match between old and new display images that are sequentially retained in the image buffer 121. That is, when it is notified that the update image is generated by the update image generation unit 111a, the difference detection unit 112 detects a difference region between generated new image information (the update image) and image information (the display image) buffered in the image buffer 121. For example, the difference detection unit 112 detects a minimum rectangle including the part where two pieces of image information do not match as a difference region. Incidentally, the difference detection unit 112 may be configured to confirm the presence or absence of the difference at predetermined time intervals.

The compression image generation unit 113 generates a compression image in which an image of the difference region detected by the difference detection unit 112 has been compression-processed for transmission. The compression image may be generated using a lossy compression scheme such as Joint Photographic Experts Group (JPEG) or lossless compression scheme such as nib.

The compression image generation unit 113 and the difference detection unit 112 are implemented by a screen transmission application program or the like.

The video generation unit 114 acquires the video information on the external storage device 103 through the event acquisition unit 111 and generates new video information to be displayed on the display terminal 200. For example, when the video information stored in the external storage device 103 is a WMV format, the video generation unit 114 converts it into an MPEG-2 format. Thus, the video generation unit 114 has a function of performing the decoding process of original video information (the decoding function) and a function of performing the encoding process of new video information (the encoding function).

Further, the video generation unit 114 generates a transmission video message to be transmitted to the display terminal 200 based on the generated new video information. For example, the video generation unit 114 generates the transmission video message by adding transmission control information such as a transmission control protocol/Internet protocol (TCP/IP) header to the video information.

Even though not shown in FIG. 2, the communication device 100 includes a session information storage unit and a session manager.

The session information storage unit stores session information representing information related to the display terminal 200 that has established a session with the communication device 100. For example, the session information storage unit stores the session information that is associated with user identification information for identifying the user, status information representing whether or not the session is in use, transmission control information representing whether transmission control is a TCP or a user datagram protocol (UDP), and format information representing a format of reproducible video information.

In a state in which one communication device 100 has established the session with a plurality of display terminals 200, the session information storage unit stores the session information including terminal identification information for identifying the display terminal 200 that is the destination of a message to be transmitted from the communication device 100.

The session manager manages communication (session) established with the communication device 100. For example, when the session with the communication device 100 is established, the session manager generates the session information that is associated with the status information of session, the transmission control information, and the like and stores the session information in the session information storage unit.

The control unit 115 controls the performance of the screen transmission system and the performance of the video streaming system. For example, the control unit 115 performs control of comparing the size of the difference region detected by the difference detection unit 112 with the threshold stored in the condition storage unit 122 and decreasing the frame rate of the video information generated by the video generation unit 114 when the size of the difference region is larger than the threshold. The details of the performance control process by the control unit 115 will be described later.

The communication processing unit 116 transmits/receives a message to/from the external device such as the display terminal 200. The communication processing unit 116 includes a transmission unit 116a that transmits the message and a reception unit 116b that receives the message. For example, the transmission unit 116a transmits a transmission image message including the compression image generated by the compression image generation unit 113 to the display terminal 200. Further, the transmission unit 116a transmits the transmission video message generated by the video generation unit 114 to the display terminal 200.

Further, the transmission unit 116a transmits the message, which is to be transmitted to the display terminal 200 as the destination specified by the session manager, through the radio base station 300.

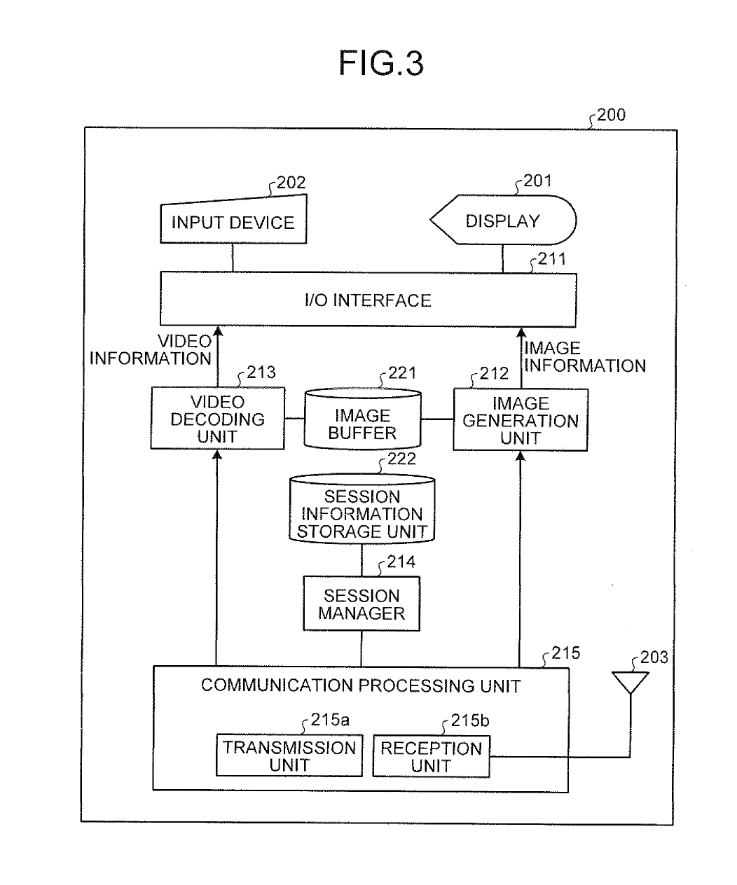

Next, a detailed configuration of the display terminal 200 will be described with reference to FIG. 3. FIG. 3 is a block diagram of the display terminal 200 according to the first embodiment. As illustrated in FIG. 3, the display terminal 200 includes a display 201, an input device 202, an antenna 203, an image buffer 221, a session information storage unit 222, an I/O interface 211, an image generation unit 212, a video decoding unit 213, a session manager 214, and a wireless communication processing unit 215. Even though not shown in FIG. 3, the display terminal 200 includes a speaker for outputting a voice.

The display 201 is a display device that is implemented by an LCD or the like. The input device 202 is implemented by a digitizer that performs an operation of moving a cursor displayed on the screen of the display 201, a touch screen, or the like. Input information acquired by the input device 202 is transferred to the I/O interface 211 (which will be described later).

The antenna 203 transmits/receives a radio wave for wireless communication with an external device such as the communication device 100.

The image buffer 221 is a storage unit that functions as a memory that stores an image and a video memory that stores a video.

The session information storage unit 222 stores session information representing information related to the communication device 100 that has established the session. For example, the session information storage unit 222 stores the session information including the status information of the session, the transmission control information, and the like.

Incidentally, the image buffer 221 and the session information storage unit 222 may be configured by any kinds of storage media that are generally used, such as a HOD, an optical disk, a memory card, a RAM, or the like.

The I/O interface 211 is an I/O interface on the display 201, and the input device 202 and is implemented by an application program such as a graphic user interface (GUI).

For example, the I/O interface 211 acquires the image information from the image buffer 221 and displays the image information on the display 201. Further, the I/O interface 211 has a function of writing GUI image information, which is generated uniquely within the display terminal 200, in the image buffer 221 in addition to a function of acquiring the image information transmitted from the communication device 100 through the image generation unit 212 and writing the image information in the image buffer 221.

The image generation unit 212 expands the compression image received from the communication device 100 and then writes the expanded image information at the designated rendering position of the rendering image buffer 221. That is, the image generation unit 212 displays a partial image, which is generated by expanding the compression image that is transmitted from the communication device 100 and then received by the wireless communication processing unit 215, at the designated position of the display 201.

The video decoding unit 213 performs the decoding process on the encoded video received from the communication device 100 and then writes the decoded video information in the rendering image buffer 221 at designated intervals. At this time, if the encoding scheme of the encoded video information transmitted from the communication device 100 is different from the encoding scheme that can be decoded by the display terminal 200, the compressed video information cannot be decoded, and thus the video cannot be reproduced.

The session manager 214 manages communication (session) established with the communication device 100. For example, when the session with the communication device 100 is established, the session manager 214 generates the session information that is associated with the status information of the session, the transmission control information, and the like and stores the session information in the session information storage unit 222.

The wireless communication processing unit 215 transmits/receives a signal to/from the radio base station 300 through the antenna 203. The wireless communication processing unit 215 includes a transmission unit 215a that transmits a message and a reception unit 215b that receives a message. The wireless communication processing unit 215 is implemented by a wireless LAN function that conforms to IEEE 802.11.

For example, the reception unit 215b of the wireless communication processing unit 215 demodulates a received radio signal to generate a packet and transfers data to the image generation unit 212 according to a message type of the packet. For example, when the packet is a packet of the transmission image message including the compression image; information, such as the compression image and the number of pixels, extracted from the packet, is transferred to the image generation unit 212. Further, for example, when the packet is a video information packet of the video streaming system (the packet of the transmission video message), the encoded video extracted from the packet is transferred to the video decoding unit 213.

Further, a method of having the user to select whether the display terminal 200 performs remote control of the communication device 100 by the screen transmission system or performs viewing of the video information by the video streaming system through the GUI on the I/O interface 211 may be considered.

In the case in which the screen transmission system is being used, the input device 202 acquires input information from the user through the digitizer, the touch screen, or the like. The input information is transmitted to the communication device 100 through the wireless communication processing unit 215 after coordinate information or the like is analyzed by the I/O interface 211. In this case, the communication device 100 executes the application process based on the input information received from the display terminal 200. When an update occurs within the screen as a result of the execution of the application process, the communication device 100 acquires image information to be updated, generates the transmission image message, and transmits the transmission image message to the display terminal 200.

In the case in which the video streaming system is being used, the user selects any one of the multimedia data, such as the video data (video information), the music data, the photographic data, and the like that are stored in the communication device 100, displayed on the GUI. The display terminal 200 decides the multimedia content to be reproduced based on the user's input information.

For example, according to the UPnP standard, identification information such as a uniform resource identifier (URI) is added to the multimedia content as an identifier for identifying the position on the network. The display terminal 200 analyzes the selection operation from the user and then starts the communication session for using the video streaming function of the communication device 100 based on the URI information. At this time, as the communication session, a hyper text transfer protocol (HTTP) or the like may be considered, but transmission control such as a real-time transport protocol (RTP) may be also used. In the case of the video streaming system, when it is detected that the display terminal 200 has started the communication session, the communication device 100 performs transmission control to transmit the video information to the display terminal 200 through the communication processing unit 116 while converting the video information stored in the external storage device 103 into new video information through the video generation unit 114.

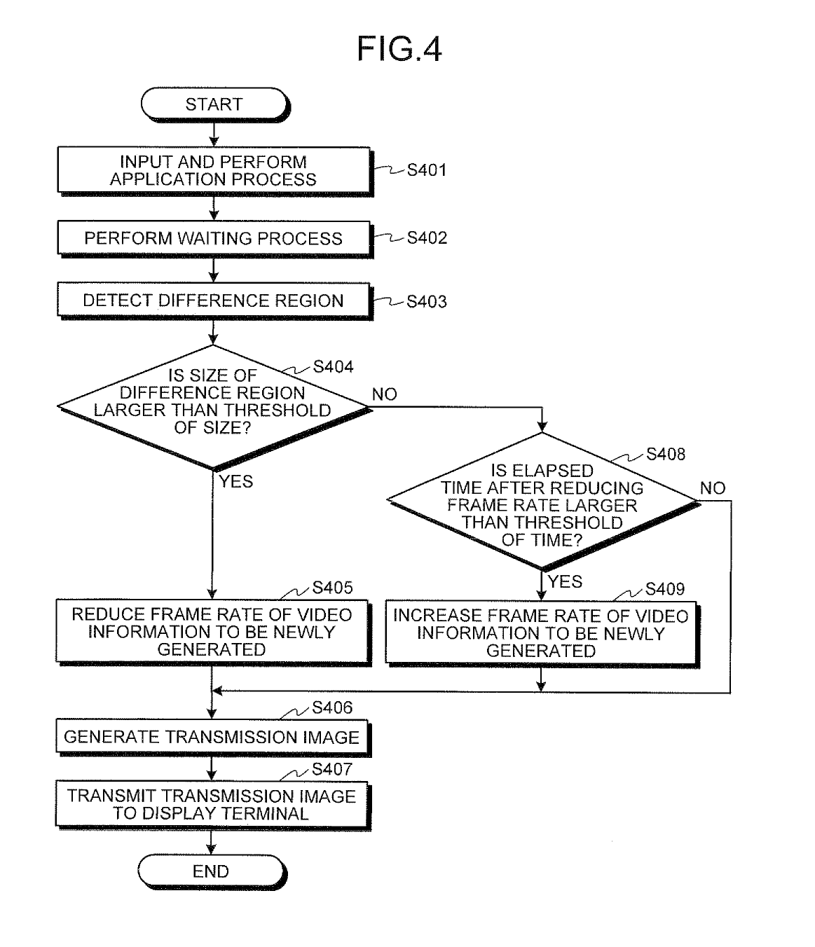

Next, an image transmission process by the communication device 100 according to the first embodiment having the above described configuration will be described with reference to FIG. 4. FIG. 4 is a flowchart illustrating the overall flow of the image transmission process in the first embodiment.

First, the application program acquires the user's input information transmitted from the display terminal 200 and executes a process according to the input information (step S401). In the case in which the screen is updated by execution of the application program, the event acquisition unit 111 acquires the screen update as an event.

The difference detection unit 112 waits until the screen update is notified from the event acquisition unit 111 or until a predetermined time for executing the difference detection process elapses (step S402).

After the waiting process, the difference detection unit 112 detects a difference region between new image information generated by the update image generation unit 111a of the event acquisition unit 111 and image information buffered in the image buffer 121 (step S403).

As described above, in the screen transmission system, only image information of the detected difference region is compressed and then transmitted to the display terminal 200. As described above, the process of the screen transmission system includes the compression process of image information that is large in processing load. For this reason, when the communication device 100 is executing the function of the video streaming system at the same time, there may be arisen a problem in that the generation time of the transmission image (compression image) becomes longer than usual due to an increase in computation complexity, and thus the response characteristic of the screen transmission system deteriorates. Further, when the communication band of the radio base station 300 that is positioned in an intermediate path between the display terminal 200 and the communication device 100 is restricted, there may be arisen a problem in that the delay time of wireless transmission becomes longer than usual, and thus the response characteristic of the screen transmission system deteriorates.

For this reason, in the present embodiment, when the size of the difference region is larger than a predetermined threshold, that is, when it is expected that the processing load of the compression process will increase, it is configured to lower the processing performance of the video streaming system in advance.

That is, the control unit 115 compares the size (the area value) of the difference region with the threshold of the area value stored in the condition storage unit 122 and judges whether or not the area value of the difference region is larger than the threshold (step S404). When the area value of the difference region is larger than the threshold (Yes in step S404), before the compression image generation unit 113 starts the process of generating the transmission image message, the control unit 115 instructs the video generation unit 114 to decrease a frame rate designated when generating new video information (a generation frame rate) (step S405).

The video generation unit 114 updates the video generation information of the video generation information storage unit 123 according to the instruction from the control unit 115. For example, when the control unit 115 gives an instruction for changing the generation frame rate to 15 frames per second (fps), the video generation unit 114 updates the frame rate of the video generation information that has been 30 fps to 15 fps.

Incidentally, the method of designating to decrease the frame rate through the control unit 115 is not limited to the above example. For example, any methods such as a method of designating an amount of decreasing the frame rate, a method of designating a rate of decreasing the frame rate, or the like may be applied.

After the update of decreasing the frame rate is performed, the video generation unit 114 generates new video information at the updated frame rate and generates the transmission video message to be transmitted to the display terminal 200. As a result, the computation complexity related to video frame generation in the video streaming function can be reduced. In the above described example, a data amount to be transmitted to the network can be reduced to half by changing the frame rate from 30 fps to 15 fps.

Meanwhile, the compression image generation unit 113 generates the transmission image message in a state in which the generation frame rate of the new video has decreased (step S406). The transmission unit 116a transmits the generated transmission image message to the display terminal 200 (step S407). As a result, an influence of the restriction in the communication band in the wireless transmission line of the network can be further reduced without extending the processing time for generating the compression image.

For example, in the communication device 100, when an update occurs in a large screen region, such as the case of movement of a window or scrolling of a web browser, the computation complexity required for generation of the compression image increases. In this case, in the present embodiment, it is configured to decrease the frame rate of generation of the video generation unit 114 that operates at the same time. As a result, the influence of the generation process of the video information by the video generation unit 114 on the generation process of the compression image is reduced, and thus the update image can be transmitted to the display terminal 200 with the excellent response characteristic.

Meanwhile, when the screen update occurs in a small region, such as the case of movement of a mouse, the computation complexity required for generation of the compression image is low. Thus, it is not necessary to decrease the generation frame rate of the video generation unit 114 that operates at the same time. Incidentally, after the generation frame rate has decreased, when the area value of the difference region is smaller than the threshold during a predetermined time, the control unit 115 performs control of increasing the generation frame rate again.

That is, when it is judged in step S404 that the area value of the difference region is not larger than the threshold (No in step S404), the control unit 115 further judges whether or not an elapsed time after the frame rate has decreased is larger than a threshold (a second threshold) concerning time that is previously decided (step S406).

When the elapsed time is larger than the threshold of the time (Yes in step S408), the control unit 115 instructs the video generation unit 114 to increase the generation frame rate for the new video information (step S409). That is, an instruction for updating information of the video generation information storage unit 123 is given.

When the generation frame rate has not decreased or when the elapsed time is not larger than the threshold of the time (No in step S408), the process continues without changing the generation frame rate.

Next, an operation example of the communication device 100 will be described. FIG. 3 is a sequence diagram illustrating an operation example of the communication device 100 of the first embodiment. In this example, it is assumed that the communication device 100 transmits the update image to one of the two display terminals 200 through the screen transmission system and transmits the video information to the other display terminal 200 through the video streaming system. Further, in this example, it is assumed that the threshold stored in the condition storage unit 122 is 307200 pixels obtained by multiplying 640 pixels of the vertical width by 480 pixels of the horizontal width.

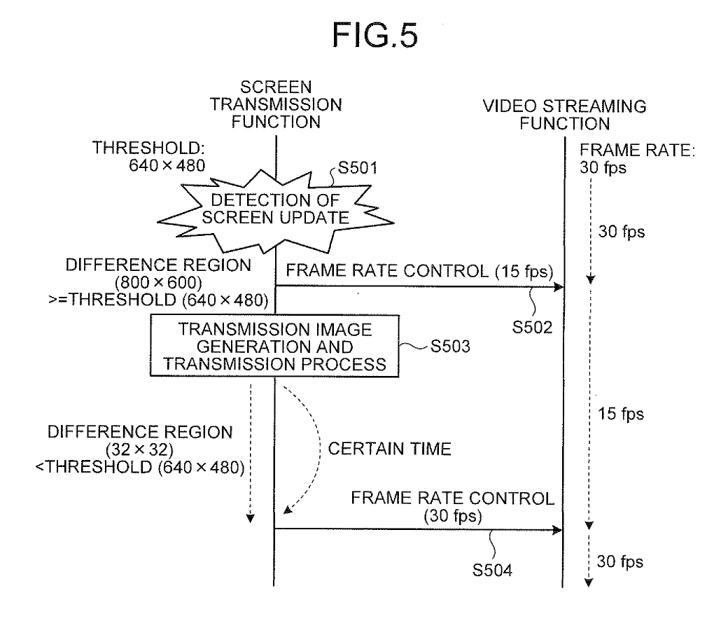

As illustrated in FIG. 5, it is assumed that the difference detection unit 112 detects the screen update (the difference region) (step S501), and the area value of the difference region is 480000 pixels obtained by 800 pixels of the vertical width by 600 pixels of the horizontal width. In this case, since the area value is larger than the threshold, the control unit 115 performs control of decreasing the generation frame rate of the video information (step S502).

In the example of FIG. 5, the generation frame rate of the video streaming changes from 30 fps to 15 fps. Thereafter, the compression image generation unit 113 performs the generation process and the transmission process of the transmission image (the compression image) (step S503). Thereafter, when the area value of the detected difference region has been smaller than the threshold over a predetermined time, the control unit 115 performs control of increasing the generation frame rate again (step S504). In the example of FIG. 5, the process of increasing from 15 fps to 30 fps again is performed.

As described above, in the communication device according to the first embodiment, when a pixel value of a region of the screen update that occurs by an operation of the application program is larger than a predetermined threshold, it is possible to decrease the generation frame rate of the video stream function prior to generation of the transmission image. Thus, it is possible to provide a plurality of display terminals with a plurality of different functions while maintaining the response characteristic related to the display of the update screen. That is, the performances of a plurality of functions provided to the display terminals can be effectively controlled.

### Second Embodiment

In the first embodiment, one fixed value has been set as the threshold of the area value. On the other hand, in a second embodiment, a plurality of thresholds are set, and a threshold to be applied among a plurality of thresholds dynamically changes based on an actual measurement value of the generation frame rate of the video information of the video streaming function.

Incidentally, the second embodiment is different in the first embodiment in a configuration of a communication device. The configuration of a communication system according to the second embodiment is the same as the configuration of the communication system according to the first embodiment which is illustrated in FIG. 1, and thus the description thereof is omitted. Further, configurations of a display terminal 200, a radio base station 300, and a network 400 are the same as in the first embodiment, and thus the descriptions thereof are omitted.

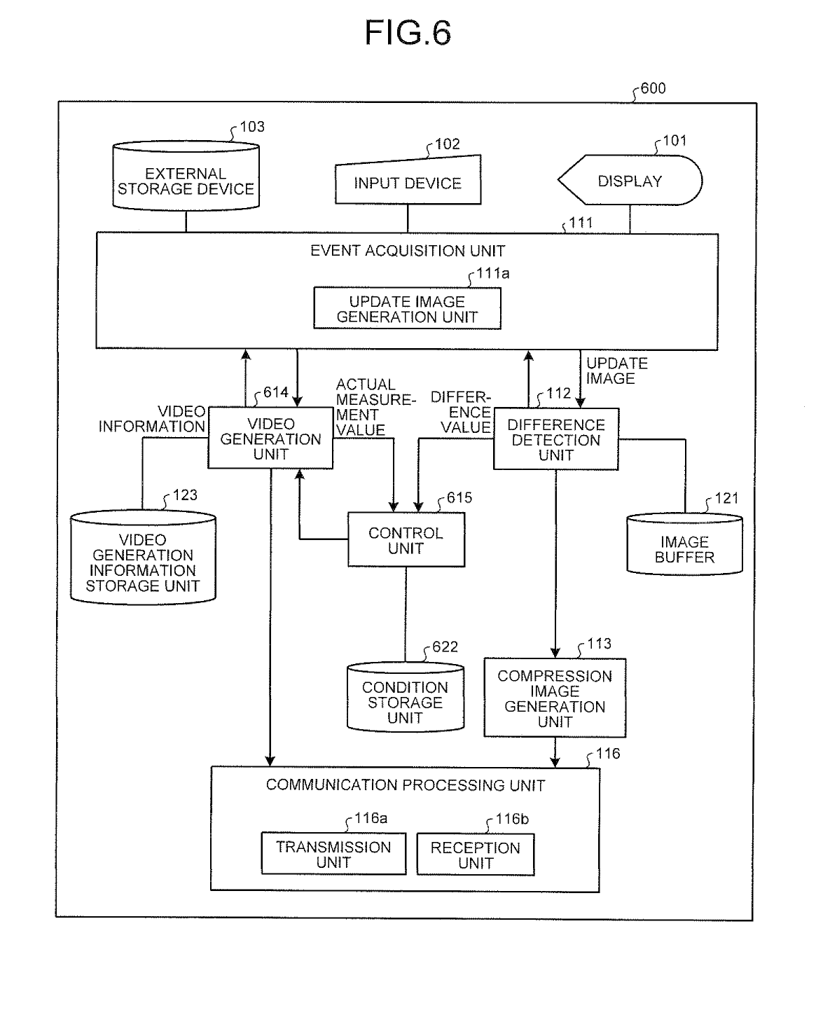

FIG. 6 is a block diagram illustrating the configuration of a communication device 600 according to the second embodiment. As illustrated in FIG. 6, the communication device 600 includes a display 101, an input device 102, an external storage device 103, an image buffer 121, a condition storage unit 622, a video generation information storage unit 123, an event acquisition unit 111, a difference detection unit 112, a compression image generation unit 113, a video generation unit 614, a control unit 615, and a communication processing unit 116.

The second embodiment is different from the first embodiment in data structure of data stored in the condition storage unit 622 and functions of the video generation unit 614 and the control unit 615. The other configurations and functions are the same as in FIG. 2 that is a block diagram illustrating the configuration of the communication device 100 according to the first embodiment and denoted by the same reference numerals, and thus a description thereof is omitted.

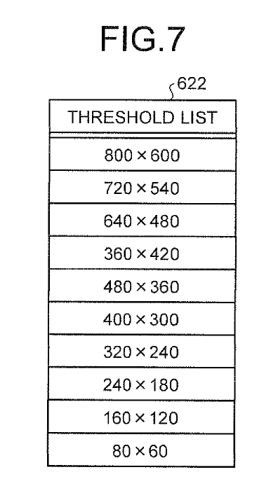

The condition storage unit 622 is different from the condition storage unit 122 of the first embodiment in that it stores a plurality of area value thresholds (a threshold list). FIG. 7 is a diagram illustrating an example of a data structure of a threshold stored in the condition storage unit 622. As illustrated in FIG. 7, the condition storage unit 622 stores a plurality of thresholds that are represented by the number of pixels of the vertical width and the number of pixels of the horizontal width in the form of a list. In FIG. 7, for easy description, the threshold is represented by the product of the number of pixels.

Returning to FIG. 6, the video generation unit 614 is different from the video generation unit 114 of the first embodiment in that a function of measuring the actual measurement value of the frame rate of the time of generating new video information is added. The video generation unit 614 calculates an actual measurement value of the frame rate by measuring the processing time from when the decoding processing of the video information stored in the external storage device 103 starts to when at least the generation process of new video information is completed.

The control unit 615 has a function of comparing the measured actual measurement value of the frame rate with a frame rate instructed to the video generation unit 614 (a target value of the frame rate) and decreasing the threshold used for comparison with the area value when the actual measurement value is smaller than the target value in addition to the function of the control unit 115 of the first embodiment.

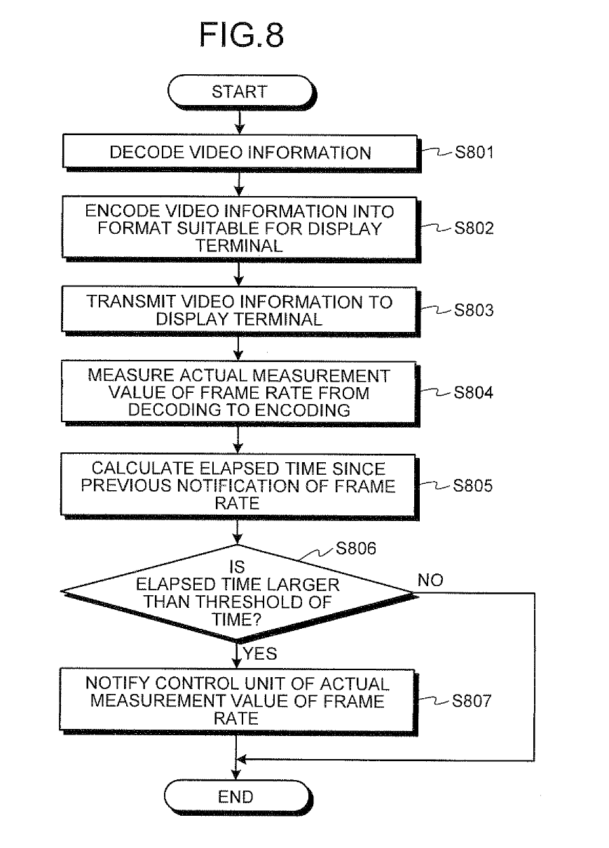

Next, a video information transmission process by the communication device 600 according to the second embodiment having the above described configuration will be described with reference to FIG. 8. The video information transmission process refers to a process for implementing the video streaming system. That is, it refers to a process in which the video generation unit 614 generates video information, which is to be transmitted to the display terminal 200, based on video information of the external storage device 103 and transmits the video information. FIG. 8 is a flowchart illustrating the overall flow of the video information transmission process in the second embodiment.

First, the video generation unit 614 starts decoding of video information in the external storage device 103 designated by the display terminal 200 (step S801). Next, the video generation unit 614 encodes the decoded video information into video information of a format suitable for the designated display terminal 200 (step S802). The video generation unit 614 transmits the encoded video information to the display terminal 200 (step S803). The process so far is a typical video information generation and transmission process that is also executed in the video generation unit 114 of the first embodiment.

In the second embodiment, the video generation unit 614 measures the actual measurement value of the frame rate that corresponds to the processing time from the start of the decoding of the video information to the completion of at least the generation process of the new video information (step S804). Alternatively, the video generation unit 614 may be configured to measure the actual measurement value of the frame rate corresponding to the processing time from the start of the decoding of video information to the transmission completion of the video information to the display terminal 200.

Next, the video generation unit 614 calculates an elapsed time after an actual measurement value of a previous frame rate has been notified to the control unit 615 (step S805). The video generation unit 614 judges whether or not the elapsed time exceeds a predetermined threshold (step S806). When the elapsed time exceeds the predetermined threshold (Yes in step S806), the measured actual measurement value is notified to the control unit 615 (step S807). When the elapsed time does not exceed the threshold (No in step S806), the actual measurement value is not notified, and the video information transmission process is finished.

As described above, in the present embodiment, the video generation unit 614 measures the actual measurement value of the frame rate and notifies the control unit 615 of the actual measurement value at predetermined time intervals. As will be described later, the control unit 615 changes the threshold that is compared with the area value based on the notified actual measurement value.

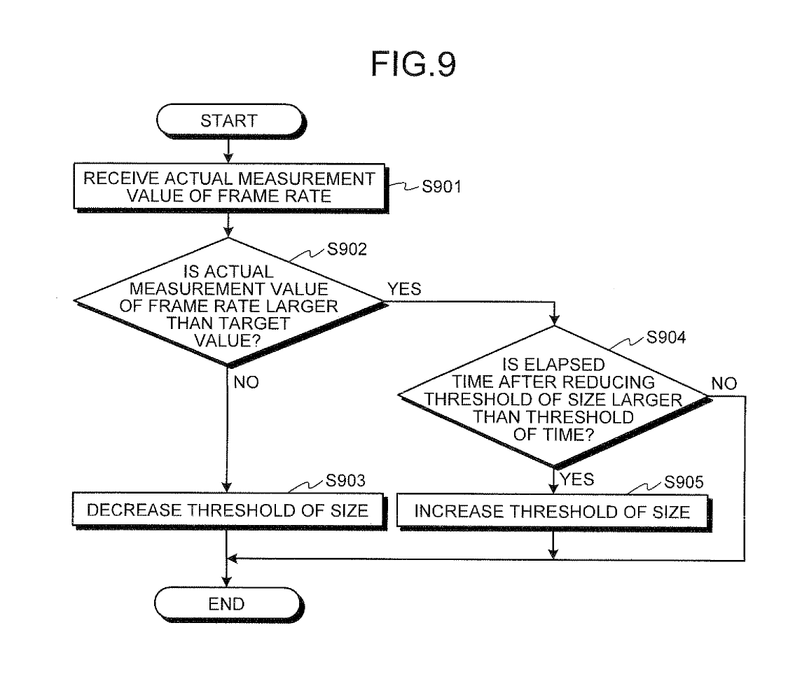

Next, a threshold change process by the communication device 600 according to the second embodiment having the above described configuration will be described with reference to FIG. 9. The threshold change process refers to a process in which the control unit 615 changes a threshold according to the actual measurement value of the frame rate. FIG. 9 is a flowchart illustrating the overall flow of the threshold change process in the second embodiment.

The threshold change process of FIG. 9 is executed in parallel with the image transmission process illustrated in FIG. 5. That is, when the threshold changes according to the actual measurement value by the threshold change process, the image transmission process of FIG. 4 is executed using the changed threshold.

First, the control unit 615 receives the actual measurement value of the frame rate from the video generation unit 614 (step S901). The control unit 615 judges whether or not the video streaming function is maintaining a predetermined performance based on the received actual measurement value. That is, the control unit 615 compares the actual measurement value with the target value instructed to the video generation unit 614 and judges whether or not the actual measurement value is larger than the target value (step S902).

The target value may be specified, for example, with reference to the frame rate of the video generation information stored in the video generation information storage unit 123 or may be specified with reference to the target value stored in any other storage unit (not shown) or the like.

When the actual measurement value is not larger than the target value (No in step S902), that is, when it is detected that the frame rate of the video streaming function is not maintained, the control unit 615 performs control of decreasing the threshold that is compared with the size (area value) of the difference region (step S903).

For example, the control unit 615 updates the threshold by setting, as a new threshold, a threshold that is one unit smaller than the currently designated threshold among a plurality of thresholds stored in the condition storage unit 622. Incidentally, the method of updating the threshold is not limited to the above example, and any methods such as a method of decreasing the threshold by reducing a predetermined value or a method of reducing the threshold at a predetermined rate may be applied.

When the actual measurement value is larger than the target value (Yes in step S902), the control unit 615 further judges whether or not an elapsed time after the threshold has decreased is larger than a threshold (a third threshold) that is previously determined concerning time (step S904).

When the elapsed time is larger than the threshold of the time (Yes in step S904), the control unit 615 performs control of increasing the threshold that is to be compared with the size (area value) of the difference region (step S905). For example, the control unit 615 updates the threshold by setting, as a new threshold, a threshold that is one unit larger than a currently designated threshold among a plurality of thresholds stored in the condition storage unit 622.

When the threshold does not decreases or when the elapsed time is not larger than the threshold of the time (No in step S904), the process continues without changing the threshold.

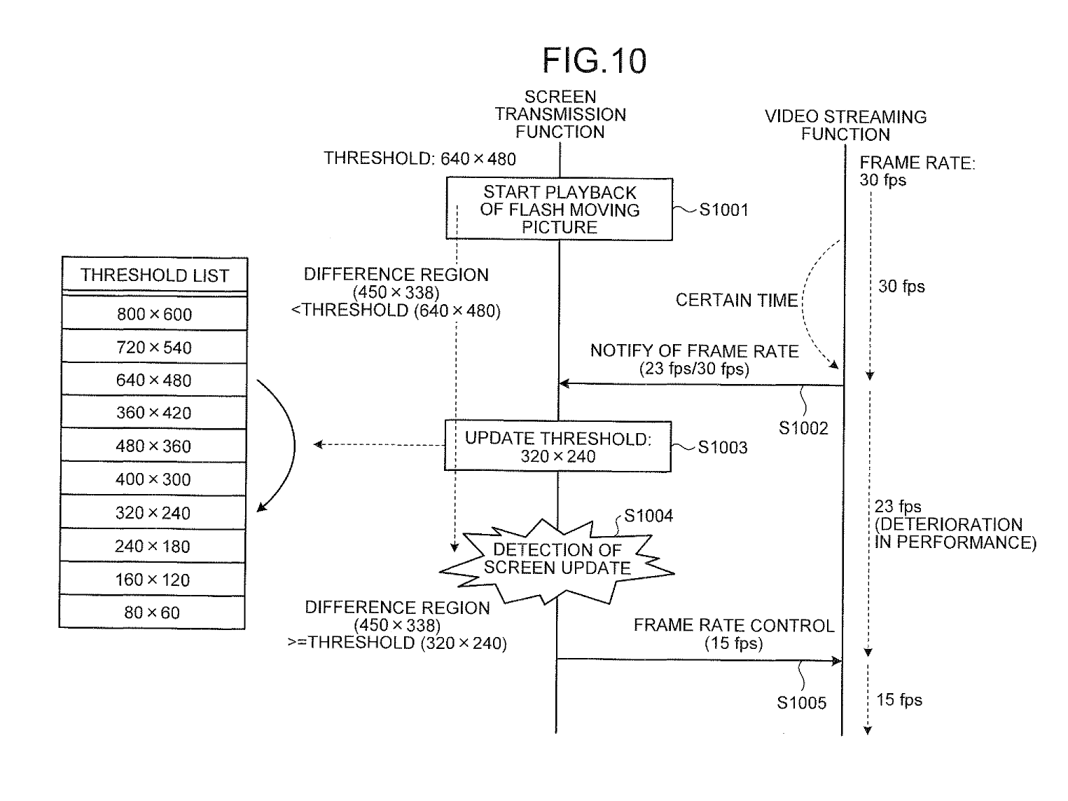

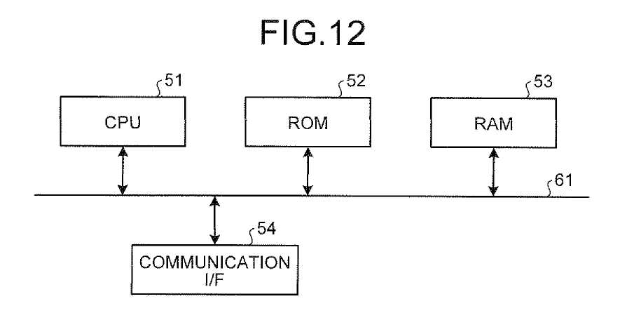

Next, an operation example of the communication device 600 will be described. FIGS. 10 and 12 are sequence diagrams illustrating an operation example of the communication device 600 of the second embodiment. In this example, it is assumed that the communication device 600 provides one of the two display terminals 200 with the screen transmission function and provides the other display terminal 200 with the video streaming function. Further, it is assumed that an initial value of the threshold is 307200 pixels obtained by multiplying 640 pixels of the vertical width by 480 pixels of the horizontal width. Further, it is assumed that an initial value of the generation frame rate stored in the video generation information storage unit 123 is 30 fps.

FIG. 10 illustrates an example in which the user activates a web browser of the communication device 600 through the display terminal 200 and plays a moving picture such as a flash through the web browser (step S1001). In the example of FIG. 10, a moving picture of vertical width 450 pixels and horizontal width 338 pixels is played. In this case, the area value of the difference region (450 pixels×338 pixels=152100 pixels) is lower than an area (in this example, 307200 pixels) that is set as the threshold. Thus, control of decreasing the generation frame rate of the video streaming function is not performed.

In the method using a predetermined fixed threshold as in the first embodiment, it is difficult to cope with a system configuration that depends on a situation such as an actual calculation processing capability of the communication device or an actual communication band on the network. Thus, in the second embodiment, the video generation unit 614 notifies the control unit 615 of the actual measurement value of the generation frame rate of the new video information at predetermined time intervals, and thus it is possible to dynamically change a value of the threshold.

That is, the video generation unit 614 notifies the control unit 615 of the actual measurement value of the frame rate at regular time intervals (step S1002). FIG. 10 illustrates an example in which the actual measurement value decreased to 23 fps is notified.

When a decrease in generation frame rate is detected, the control unit 615 performs control of decreasing the threshold. In the example of FIG. 10, the threshold is updated from 307200 pixels to 76800 pixels obtained by multiplying vertical width 320 pixels by horizontal width 240 pixels (step S1003).

Thereafter, when the screen update is detected (step S1004), the updated threshold is compared with the area value of the difference region, and when the area value is larger than the threshold, control of decreasing the generation frame rate in the video streaming function is performed (step S1005).

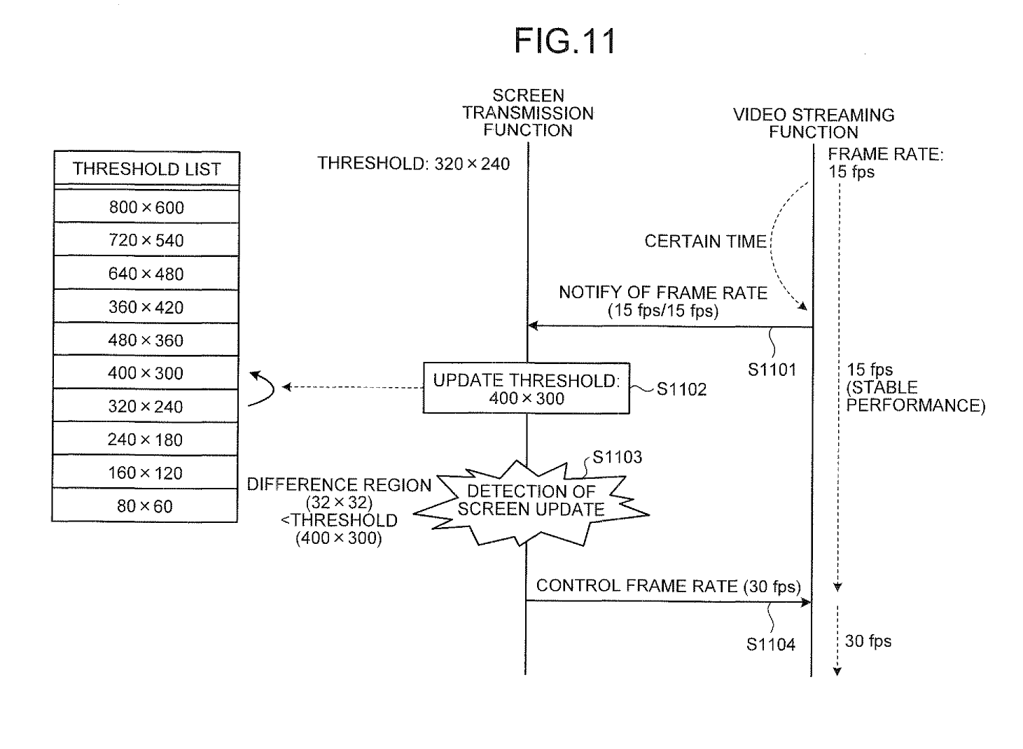

Further, since the video generation unit 614 periodically notifies the control unit 615 of the actual measurement value of the generation frame rate, when it is detected that the generation frame rate is maintaining a predetermined performance in a state in which the threshold has decreased, the control unit 615 performs control of increasing the threshold. FIG. 11 is a sequence diagram illustrating an operation example of this case.

FIG. 11 illustrates an example in which since the actual measurement value of the frame rate notified from the video generation unit 614 (step S1101) has achieved the target value, the threshold decreased to 76800 pixels increases to 120000 pixels obtained by multiplying vertical width 400 pixels by horizontal width 300 pixels (step S1102). In FIG. 11, when the screen update is detected (step S1103), the control unit 615 compares the updated threshold with the area value of the difference region. In FIG. 11 illustrates an example in which since it is judged that the area value is smaller than the changed threshold and a certain time has elapsed after the frame rate has decreased, control of increasing the generation frame rate is performed (step S1104).

As described above, in the communication device according to the second embodiment, the threshold used for a judgment on whether to decrease the frame rate of the video streaming can be dynamically changed based on the actual measurement value. Thus, it is possible to provide a plurality of display terminals with a plurality of different functions in view of a calculation capability of the communication device or a communication band of a network between the display terminals and the communication device.

Next, hardware configurations of the communication device and the display device (display terminal) according to the first and second embodiments will be described with reference to FIG. 12. FIG. 12 is an explanation diagram illustrating hardware configurations of the communication device and the display device according to the first and second embodiments.

The communication device and the display device according to the first and second embodiments include a control device such as a central processing unit (CPU) 51, a storage device such as a read only memory (ROM) 52 and a RAM 53, a communication I/F 54 that is connected to a network to perform communication, an external storage device such as a HDD and a compact disc (CD) drive device, a display device such as a display device, an input device such as a keyboard or a mouse, and a bus 61 that connects the components.

A communication program executed by the communication device according to the first and second embodiments is provided as recorded in a computer readable recording medium such as a compact disk read only memory (CD-ROM), a flexible disk (ED), a compact disk recordable (CD-R), and a digital versatile disk (DVD) in the form of a file having an installable format or an executable format.

The communication program executed by the communication device according to the first and second embodiments may be configured to be provided in such a manner that it is stored on a computer connected to a network such as the Internet and downloaded through the network. The communication program executed in the communication device according to the first and second embodiments may be provided or distributed through the network such as the Internet.

The communication program according to the first and second embodiments may be incorporated in the ROM or the like in advance and provided.

The communication program executed by the communication device according to the first and second embodiments is configured as a module including the above described components (the event acquisition unit, the difference detection unit, the compression image generation unit, the video generation unit, the control unit, the communication processing unit, and the session manager). In actual hardware configuration, as the CPU 51 (a processor) reads and executes the communication program from the storage medium, the components are loaded onto a main storage device, so that the above described components are generated on the main storage device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device connected to a display device, which displays an image, via a network, comprising:
an image storage unit that stores a display image to be displayed on the display device;
an update image generation unit that generates an update image used to update the display image;
a detection unit that detects a difference region representing a region in which pieces of pixel information do not match between the update image and the display image;
a compression image generation unit that generates a compression image in which an image of the difference region is compressed;
a moving picture generation unit that generates a moving picture at a designated frame rate;
a control unit that compares the size of the difference region with a first threshold and performs control of decreasing a frame rate designated to the moving picture generation unit when the size of the difference region is larger than the first threshold; and
a transmission unit that transmits the compression image and the moving picture to the display device.

2. The communication device according to claim 1,
wherein the control unit performs control of decreasing the frame rate designated to the moving picture generation unit before the compression image generation unit generates the compression image when the size of the difference region is larger than the first threshold.

3. The communication device according to claim 2,
wherein after control of decreasing the frame rate is performed, the control unit compares a time during which the size of the difference region becomes equal to or less than the first threshold with a predetermined second threshold and performs control of increasing the frame rate designated to the moving picture generation unit when the time is larger than the second threshold.

4. The communication device according to claim 3,
wherein the moving picture generation unit measures an actual measurement value of a frame rate of the generated moving picture, and
the control unit compares the actual measurement value with the frame rate designated to the moving picture generation unit and updates the first threshold to decrease the first threshold when the actual measurement value is smaller than the frame rate designated to the moving picture generation unit.

5. The communication device according to claim 4,
wherein after the first threshold is updated to decrease, the control unit compares a time during which the actual measurement value becomes equal to or more than the frame rate designated to the moving picture generation unit with a predetermined third threshold and updates the first threshold to increase the first threshold when the time is larger than the third threshold.

6. A communication method executed by a communication device that is connected to a display device, which displays an image via a network, and includes an image storage unit, which stores a display image to be displayed on the display device, the communication method comprising;
generating an update image for updating the display image;
detecting a difference region representing a region in which pieces of pixel information do not match between the update image and the display image;
generating a compression image in which an image of the difference region is compressed;
generating a moving picture at a designated frame rate;
comparing the size of the difference region with a first threshold and performing control of decreasing the designated frame rate when the size of the difference region is larger than the first threshold; and
transmitting the compression image and the moving picture to the display device.

7. A communication program product having a computer readable medium including programmed instructions, wherein the instructions, when executed by a computer, cause the computer to perform:
generating an update image for updating a display image;
detecting a difference region representing a region in which pieces of pixel information do not match between the update image and the display image;
generating a compression image in which an image of the difference region is compressed;
generating a moving picture at a designated frame rate;
comparing the size of the difference region with a first threshold and performing control of decreasing the designated frame rate when the size of the difference region is larger than the first threshold; and
transmitting the compression image and the moving picture to a display device.
